(19) United States
(12) Patent Application Publication
(10) Pub. No.: US 2018/0114373 A1
(43) Pub. Date: Apr. 26, 2018

(54) METHOD AND SYSTEM FOR GENERATING PARKING VOUCHERS BASED ON GEOLOCATION AND PURCHASE DATA

(71) Applicant: MasterCard International Incorporated, Purchase, NY (US)

(72) Inventors: Erica Joann ROBEEN, Hardin, IL (US); Corey M. HIVELY, O'Fallon, MO (US); Mahesh NAGURE, O'Fallon, MO (US)

(73) Assignee: MasterCard International Incorporated, Purchase, NY (US)

(21) Appl. No.: 15/333,582

(22) Filed: Oct. 25, 2016

(51) Int. Cl. G07B 15/02; G06Q 30/00

(52) U.S. Cl. CPC G07B 15/02; G06Q 30/018

(57) ABSTRACT

A method for parking validation based on merchant rule compliance includes: receiving a parking notification, wherein the parking notification includes at least a geographic area identifier and is received from a computing device; executing a first query to identify one or more merchant rules related to a geographic area associated with the geographic area identifier; electronically transmitting the one or more merchant rules to the computing device; receiving an action notification related to an action performed by a user of the computing device; executing a second query to identify a specific merchant rule of the one or more merchant rules related to the received action notification; and electronically transmitting a validation notification to the computing device based on the specific merchant rule.

### FIELD

The present disclosure relates to a computer based method and system for parking validation based on merchant rule compliance, specifically the use of device geolocation and compliance with previously established merchant rules to provide for parking validation as a result of physical attendance at merchants and/or transacting with merchants.

### BACKGROUND

In many places, fees may be charged to an individual for parking at predetermined locations. In some cases, to encourage an individual to visit merchants located near the parking area, or to compensate the individual for having to pay for parking when visiting a merchant, some parking vendors enable merchants to provide validation. Validation provides the individual with a discount, in some cases for the entire parking amount, as a result of actions taken with a merchant that is partners with the parking vendor. In some cases, the merchant may provide validation for just being visited, to encourage individuals to enter the merchant's store where the merchant hopes to entice the individual into a purchase. In other cases, the merchant may require that the individual make a purchase, to offset the amount saved via the validation.

Validation may be a useful tool for parking vendors, merchants, and individuals as it may help further the interests of each of the parties. However, traditional validation often involves the printing of a physical ticket at the parking area or structure, the taking of the physical ticket to the merchant for validation, stamping of the ticket by the merchant for the validation, the presentation of the ticket to an employee at the exit of the parking area or structure, and evaluation by the employee to determine proper validation. These traditional processes are cumbersome and require participation by the individual, who must remember to bring their ticket with them to the merchant and present it for validation, the merchant, who must have the resources to perform validation and train employees to do so, and the parking vendor, who must hire and train employees to review validations rather than rely on automated payment and ticketing systems. It also presents purely technical challenges in reliably reading by a computer connected scanner physical tickets that might be damaged or alteration by the consumer, processing the ticket at a remote point of interaction and possibly transmitting the ticket information to a central location for possible distribution, authentication and validation, distributing software and/or programmed hardware to the merchants and the parking facility that might have to be tailored to each system and its points of interaction, and possibly requiring human intervention in the process, even if technology is employed. Further, such systems usually require that all merchants offer the same or similar discount, particularly in shopping mall and shopping districts, where there are multiple merchants. These technical challenges raise costs, are difficult to implement, and often the user experience less than optimal.

Thus, there is a need for a technical solution that improves the technology by providing for automated parking validation that complies with rules set for validation, but accomplishes validation and review thereof via automated means to facilitate implementation for individuals, merchants, and parking vendors.

### SUMMARY

The present disclosure provides a description of systems and methods for parking validation based on merchant rule compliance. A geographic location is read from a computing device associated with an individual to determine when the individual visits a parking area or structure, where afterward the system automatically monitors for compliance with merchant rules that are associated with validation, such as determining when the individual visits a merchant or transacts with a merchant. Once the individual has complied, a notification is sent to the computing device to indicate validation, which may be presented to the parking vendor for use in deducting the parking amount to be paid. This may eliminate several steps and communications, as well as increase reliability as compared to prior systems, depending on implementation. Also, because it can be implemented centrally, perhaps by a major card processor providing the mobile application to the public, a more standardized system can be implemented, thereby reducing the complexity and additional programming it might otherwise take to implement on a merchant-by-merchant, garage-by-garage basis.

A method for parking validation based on merchant rule compliance includes: receiving, by a receiving device of a processing server, a parking notification, wherein the parking notification includes at least a geographic area identifier and is received from a computing device; executing, by a querying module of the processing server, a first query to identify one or more merchant rules related to a geographic area associated with the geographic area identifier; electronically transmitting, by a transmitting device of the processing server, the one or more merchant rules to the computing device; receiving, by the receiving device of the processing server, an action notification related to an action performed by a user of the computing device; executing, by the querying module of the processing server, a second query to identify a specific merchant rule of the one or more merchant rules related to the received action notification; and electronically transmitting, by the transmitting device of the processing server, a validation notification to the computing device based on the specific merchant rule.

Another method for parking validation based on merchant rule compliance includes: identifying, by a geolocation module of a computing device, a geographic location of the computing device; electronically transmitting, by a transmitting device of the computing device, at least the geographic location or an associated geographic area identifier to a processing server; receiving, by a receiving device of the computing device, one or more merchant rules from the processing server; receiving, by the receiving device of the computing device, a validation notification from the processing server, wherein the validation notification is based on a specific merchant rule of the one or more merchant rules; and displaying, by a display device of the computing device, validation data based on the received validation notification.

A system for parking validation based on merchant rule compliance includes: a receiving device of a processing server configured to receive a parking notification, wherein the parking notification includes at least a geographic area identifier and is received from a computing device; a querying module of the processing server configured to execute a first query to identify one or more merchant rules related to a geographic area associated with the geographic area identifier; and a transmitting device of the processing server configured to electronically transmit the one or more merchant rules to the computing device. The receiving device of the processing server is further configured to receive an action notification related to an action performed by a user of the computing device. The querying module of the processing server is further configured to execute a second query to identify a specific merchant rule of the one or more merchant rules related to the received action notification. The transmitting device of the processing server is further configured to electronically transmit a validation notification to the computing device based on the specific merchant rule.

Another system for parking validation based on merchant rule compliance includes: a geolocation module of a computing device configured to identify a geographic location of the computing device; a transmitting device of the computing device configured to electronically transmit at least the geographic location or an associated geographic area identifier to a processing server; a receiving device of the computing device configured to receive one or more merchant rules from the processing server, and receive a validation notification from the processing server, wherein the validation notification is based on a specific merchant rule of the one or more merchant rules; and a display device of the computing device configured to display validation data based on the received validation notification.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the validation of parking based on merchant rule compliance in accordance with exemplary embodiments.

FIG. 2 is a block diagram illustrating the processing server of the system of FIG. 1 for validating parking based on merchant rule compliance in accordance with exemplary embodiments.

FIG. 3 is a block diagram illustrating the computing device of the system of FIG. 1 for the receipt of a parking validation notification in accordance with exemplary embodiments.

FIG. 4 is a flow diagram illustrating a process for the validation of parking based on merchant rule compliance using the system of FIG. 1 in accordance with exemplary embodiments.

FIG. 5 is a flow diagram illustrating a process for determining individual compliance with merchant validation rules for parking validation in the processing server of FIG. 2 in accordance with exemplary embodiments.

FIGS. 6 and 7 are flow charts illustrating exemplary methods for parking validation based on merchant rule compliance in accordance with exemplary embodiments.

FIG. 8 is a flow diagram illustrating the processing of a payment transaction in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

### System for Automated Parking Validation

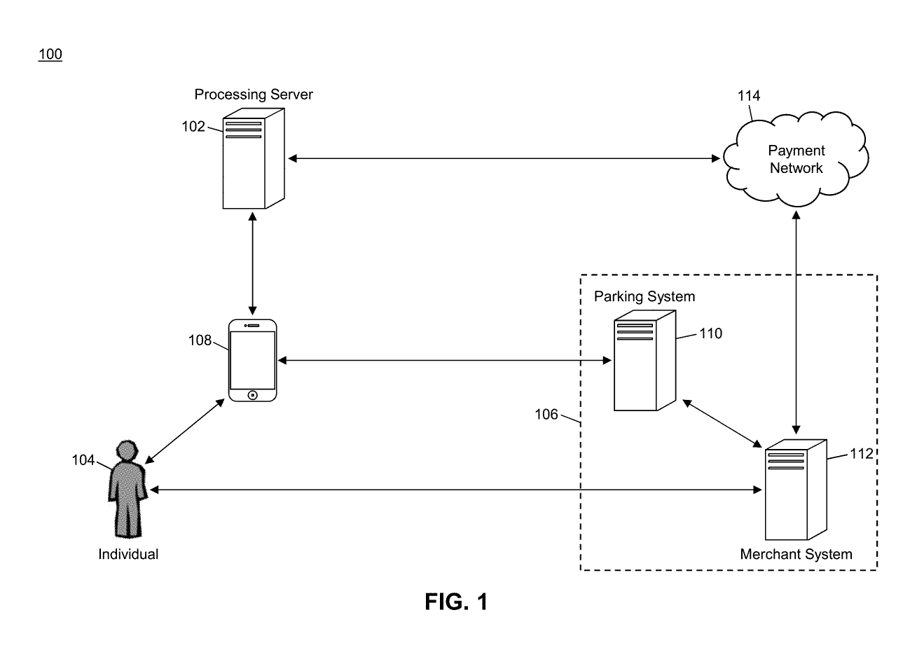

FIG. 1 illustrates a system 100 for the automation of parking validation via the use of merchant validation rules that utilize geographic location data of a user computing device and additional user actions related thereto.

The system 100 may include a processing server 102. The processing server 102, discussed in more detail below, may be configured to identify instances where automated parking validation should occur based on actions of an individual 104 related to merchant validation rules associated with a parking area 106. The individual 104 may arrive at a parking area 106, which may be a parking lot, parking garage, or other area in which the individual 104 may parked and be charged as a result, such as street parking, for which validation may be provided by one or more merchants near or associated with the parking area 106.

The individual 104 may possess a computing device 108. The computing device 108, discussed in more detail below, may be configured to identify a geographic location of the computing device 108 and electronically transmit the geographic location to the processing server 102, which may be used thereby to determine when the individual 104 has arrived at the parking area 106. The computing device 108 may be any type of computing device suitable for performing the functions discussed herein, such as a cellular phone, smart phone, smart watch, wearable computing device, implantable computing device, laptop computer, notebook computer, tablet computer, desktop computer, etc.

The geographic location of the computing device 108 may be identified using any suitable method that will be apparent to persons having skill in the relevant art. For instance, in a first example, the geographic location of the computing device 108 may be identified using cellular network triangulation. In a second example, the geographic location of the computing device 108 may be identified using the global positioning system. In a third example, the geographic location of the computing device 108 may be identified based on detection thereof by a communication network having a known geographic location. In a fourth example, the geographic location of the computing device 108 may be identified by the scanning of a machine-readable code by the computing device 108 that is displayed at a known geographic location or that may have the geographic location encoded therein. The computing device 108 may electronically transmit the geographic location or other value associated therewith (e.g., an identifier associated with the geographic location, such as an identification number) to the processing server 102 using a suitable communication network and method, such as via the Internet, cellular communication network, a local area network, etc.

The processing server 102 may receive the geographic location of the computing device 108, which may be identified as being located at the parking area 106. The processing server 102 may then identify a plurality of merchant validation rules associated with the parking area 106. Merchant validation rules may be rules that, when complied with by the individual 104, will result in validation of their parking. In some instances, a merchant validation rule may indicate the effect of the validation, such as if the parking is to be free, an amount of discount, an amount of time that the validation is acceptable (e.g., if the individual 104 leaves the parking area 106 within a predetermined period of time), or a combination thereof, such as where the validation provides free parking for up to two hours from entry and a discounted rate for any time beyond the two hours. The merchant validation rules may be stored in the processing server 102 and associated with the parking area's geographic location or associated identifier, which may be used in identification thereof.

The merchant validation rules may be submitted to the processing server 102 by the merchants associated therewith or by a parking vendor associated with the parking area 106 with whom the parking may be validated. In such instances, the processing server 102 may receive the merchant validation rules for the parking area 106 from a parking system 110 associated with the parking vendor and/or a merchant system 112 associated with merchants with whom parking in the parking area 106 may be validated. In some cases, merchant validation rules submitted by merchants may be confirmed through the parking system 110 for the parking vendor, to ensure that all validations performed via the processing server 102 are proper.

In some embodiments, when the processing server 102 receives the indication that the individual 104 has entered the parking area 106, the processing server 102 may provide the merchant validation rules or data associated therewith to the individual 104. In such embodiments, the processing server 102 may electronically transmit the identified merchant validation rules or data associated therewith (e.g., criteria for validation, effect of validation, etc.) to the computing device 108 from which the geographic location was received. The individual 104 may then be able to view, using the computing device 108, the opportunities to have their parking validation and how the validations may differ from one another, if applicable. For instance, the individual 104 may plan on visiting two different merchants offering validation, where one's validation provides a larger discount, and thus may seek validation via that merchant in particular.

The processing server 102 may determine when an individual has satisfied a merchant validation rule based on actions taken after having parked in the parking area 106. Individual actions that may satisfy merchant validation rules, discussed in more detail below, may include the visiting of a merchant, participation in a payment transaction with the merchant, etc. The processing server 102 may, as discussed below, receive information associated with the individual action from the computing device 108 or other computing device, computing system, or entity in the system 100. The processing server 102 may determine if the action satisfies the merchant validation rule based on criteria associated therewith. If the individual 104 has not satisfied the action, then the processing server 102 may not perform any additional actions. In some instances, the processing server 102 may notify the If the individual 104 has satisfied the action, then their parking may be validated accordingly.

Validation may be performed via the electronic transmission of a validation notification from the processing server 102 to the computing device 108. The validation notification may include data associated with the validation, which may be used by the parking system 110 in verifying the validation and determining what cost may be needed, if any, to pay for the parking following the validation. For instance, the data may include the merchant validation rule that was satisfied and the data used to satisfy the validation, as discussed below. The notification may be received by the computing device 108. The computing device 108 may then be used by the individual 104 to convey the validation data to the parking system 110.

In one embodiment, the computing device 108 may electronically transmit the validation data to the parking system 110, such as using near field communication, radio frequency, Bluetooth, or other communication method. In another embodiment, the computing device 108 may be configured to display a machine-readable code, such as a bar code or quick response code that is encoded with the validation data. In yet another embodiment, the computing device 108 may display the validation data directly, which may be read by an employee of the parking vendor as a user of the parking system 110, such as for entry therein. In some instances, the computing device 108 may be programmed for use with multiple methods of conveyance, where the individual 104 may select (e.g., via an input of the computing device 108) the method to be used. For example, limitations of specific parking systems 110 may necessitate the use of certain methods, where the individual 104 may select the method to be used based on the specifications of the parking system 110 where payment is to be made.

The parking system 110 may receive the validation data from the computing device 108, verify that validation was appropriate based thereon, and may deduct or negate the cost of parking accordingly. The individual 104 may then pay for parking, if necessary, and leave the parking area 106.

The methods and systems discussed herein may thus enable an individual 104 to have their parking automatically validated by the processing server 102 based on their actions following parking in the parking area 106, where attendance at the parking area 106 may be identified via the individual's computing device 108. In one embodiment, the individual's parking may be validated by visiting a merchant associated with the parking area 106. In such an embodiment, the individual 104 may provide notification to the processing server 102 of their visiting of the merchant by reporting their geographic location at the merchant. The geographic location may be reported via the computing device 108 or the merchant system 112 of the merchant, and may be identified using any suitable method. For instance, in one example, the computing device 108 may identify its geographic location and report it to the processing server 102, which may identify the location as satisfying a corresponding merchant validation rule. In another example, the individual 104 may use the computing device 108 to read a machine-readable code displayed at the merchant, where data encoded therein may be electronically transmitted to the processing server 102. In yet another example, the computing device 108 may detect a signal being emitted by a transmitting device at the merchant, where detection thereof may be reported to the processing server 102 to indicate the visit to the merchant.

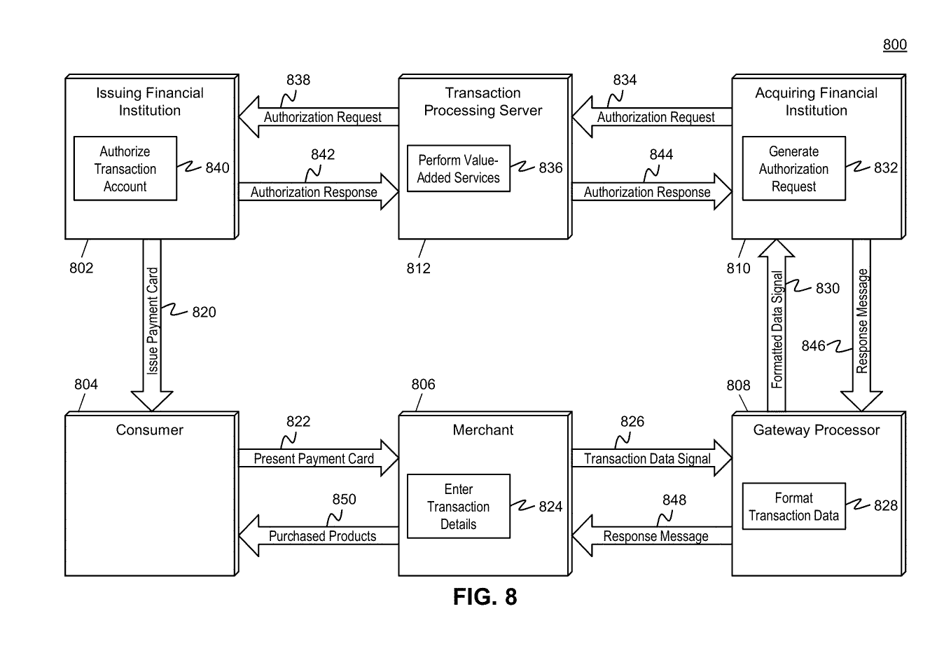

In another embodiment, a merchant validation rule may require the conducting of a payment transaction with a merchant associated with the parking area 106. In such embodiments, the individual 104 may initiate a payment transaction at a merchant system 112. The merchant system 112 may electronically transmit transaction data to a payment network 114 for processing thereof using traditional methods and systems, such as described in more detail below with respect to the process 800 illustrated in FIG. 8. The processing server 102 may receive transaction data for the payment transaction from the payment network 114, or directly from the merchant system 112, which may be used to determine if a merchant validation rule has been satisfied.

In some cases, the payment transaction may be matched to the individual 104 via the transaction account used to fund the payment transaction. In such cases, the individual 104 may register one or more transaction accounts with the processing server 102, such as by providing the transaction account numbers associated therewith to the processing server 102 (e.g., via the computing device 108). The processing server 102 may thus identify payment transactions associated with the individual 104 based on the transaction account number included in the transaction data that corresponds to the transaction account being used to fund the transaction. In other cases, the transaction data may include a unique identification value, which may be used by the processing server 102 to match the transaction to the individual 104. For instance, the computing device 108 may convey a verification number (e.g., generated thereby or provided by the processing server 102) to the merchant system 112 (e.g., via near field communication, display of a machine-readable code, display of the code for reading by the individual 104 or an employee of the merchant, etc.), which may be included in the transaction data submitted for the transaction, and identified by the processing server 102 accordingly. In instances where the processing server 102 does not provide the verification code to the computing device 108, the computing device 108 may electronically transmit the verification code to the processing server 102 for identification of the payment transaction.

The processing server 102 may then determine if the merchant validation rule was satisfied based on the transaction data. For instance, in some cases, validation may be approved upon the conducting of any transaction involving the individual 104 and the merchant (e.g., as may be identified from the transaction data, such as a merchant identification number). In other cases, validation may require a minimum transaction amount (e.g., a purchase of at least $5 for validation). In some instances, there may be multiple validation rules that may be applicable, such as where a larger discount may be provided by validation depending on the transaction amount. In such instances, the processing server 102 may identify each satisfied merchant validation rule, and may select the strongest in terms of benefit for the validation.

The methods and systems discussed herein may enable an individual 104 to park in a parking area 106 and receive parking validation automatically when actions that satisfy merchant validation rules are performed. Via the use of the processing server 102 and the computing device 108, validation may be identified without the individual 104 having to perform extra actions or remember to present tickets to merchants, without the merchant having to be configured to perform validations or train employees therefor, and without parking systems to have to train employees to verify validations. As a result, the methods and systems discussed herein provide for parking validations that are more convenient to every entity involved, and allow for greater robustness as validation rules may be readily changed using the processing server 102, without the need for modification to merchant systems 112 or parking systems 110.

In some embodiments, validation may be split among one or more merchants. For instance, the processing server 102 may determine that, based on the actuals of the individual 104, multiple merchant validation rules were satisfied by the individual 104 prior to the individual 104 paying for parking. For instance, the individual 104 may visit a first merchant that provides validation upon visiting and may transact with a second merchant that requires transacting for validation. In such instances, the benefits of validation provided to the individual 104 may be shared or split among each of the merchants. For instance, in a first example, each merchant may provide a discount on parking through the validation, which may be combined. In a second example, the merchants may split the full cost or a portion of the cost of parking to provide the individual 104 with free parking. In a third example, the first merchant may pay an amount that would discount the parking cost while the second merchant may pay the remaining parking cost, based on their associated merchant validation rules. Still further, when the two or more merchants offer different validation benefits, one benefit/merchant can be chosen over others, depending on rules programmed into the processing server 102. In some cases, the split or choice may be based on the satisfied merchant validation rules, agreements between the involved merchants, or other suitable criteria.

### Processing Server

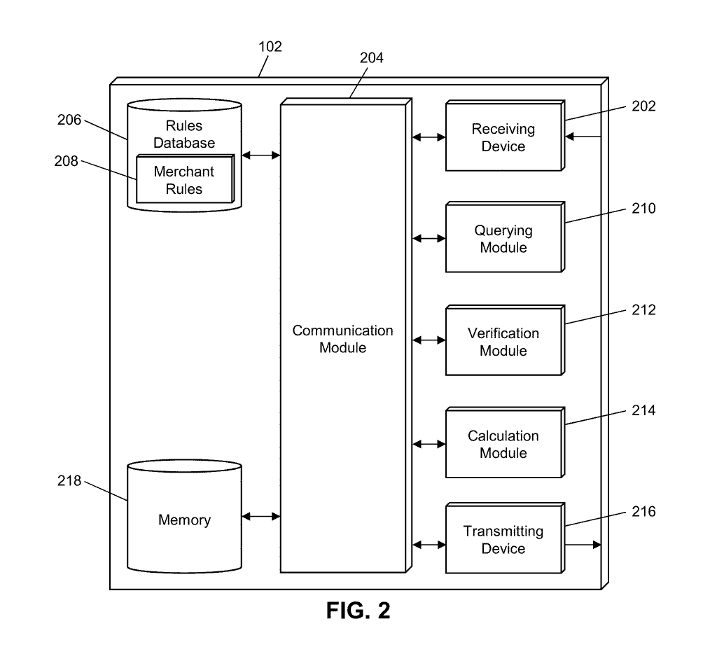

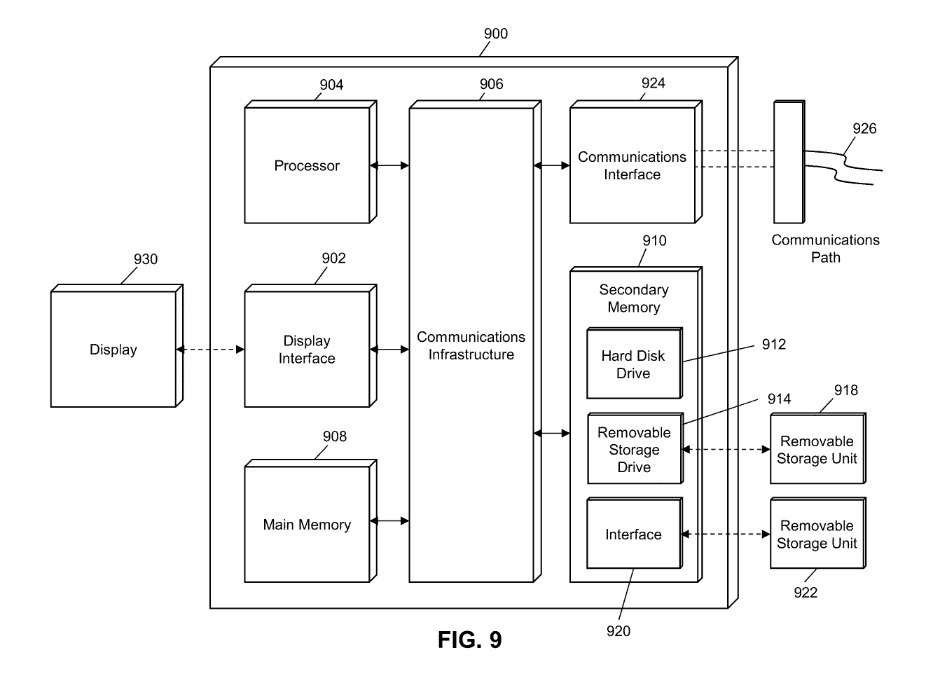

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 900 illustrated in FIG. 9 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 114 for the transmission of transaction messages that include sensitive financial data and information. In some instances, the receiving device 202 may also be configured to receive data from computing devices 109, parking systems 110, merchant systems 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing devices 108 that are superimposed or otherwise encoded with geographic location data for identifying when an individual 104 enters a parking area 106 and/or other data associated with actions of the individual 104, such as related to entry at a merchant location, initiation of a payment transaction with a merchant system 112, etc. The receiving device 202 may also be configured to receive data signals electronically transmitted by payment networks 114 that are superimposed or otherwise encoded with transaction data for a payment transaction involving the individual 104. In some instances, the receiving device 202 may also receive data signals electronically transmitted by parking systems 110 or merchant systems 112, such as may be superimposed or otherwise encoded with merchant validation rules or modifications thereto, action notifications, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, verification module 212, calculation module 214, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include a rules database 206. The rules database 206 may be configured to store a plurality of merchant rules 208 using a suitable data storage format and schema. The rules database 206 may be a relational database that utilizes structured query language for the storage, identification, modifying, updating, accessing, etc. of structured data sets stored therein. Each merchant rule 208 may be a structured data set configured to store data related to a merchant validation rule. Each merchant validation rule may include at least criteria for determining applicability or compliance with the related rule, and may also include validation data associated with an effect of the rule on parking validation. For instance, a merchant rule 208 may specify that an individual 104 must transact with a specific merchant for at least $5, where the effect may be a reduction of the cost of parking by $10. Each merchant rule 208 may also include data associated with a geographic location, such as a location identifier, geographic coordinates, etc., which may correspond to a parking area 106 with which the related merchant validation rule is associated.

The processing server 102 may include a querying module 210. The querying module 210 may be configured to execute queries on databases to identify information. The querying module 210 may receive one or more data values or query strings, and may execute a query string based thereon on an indicated database, such as the rules database 206, to identify information stored therein. The querying module 210 may then output the identified information to an appropriate engine or module of the processing server 102 as necessary. The querying module 210 may, for example, execute a query on the rules database 206 to identify a plurality of merchant rules 208 that are associated with a parking area 106 (e.g., where an individual 104 has entered based on location data provided by the computing device 108), such as based on a location identifier associated therewith.

The processing server 102 may also include a verification module 212. The verification module 212 may be configured to verify data that is received as input therein for performing the functions of the processing server 102. The verification module 212 may receive data as input, may attempt to verify the data, and may output a result of the attempted verification to another module or engine of the processing server 102. For example, the verification module 212 may be configured to verify if an action performed by the individual 104 satisfies a previously identified merchant rule 208.

The processing server 102 may also include a calculation module 214. The calculation module 214 may be configured to perform calculations for the processing server 102 for performing the functions of the processing server 102 as discussed herein. The calculation module 214 may receive data and instructions related thereto as input, may perform requested calculations based on the instructions and data, and may output a result of the calculations to another module or engine of the processing server 102. For example, the calculation module 214 may be configured to calculate a new parking amount or a discount for parking based on data included in a merchant rule 208 that the individual 104 has satisfied, as validation for complying with the merchant rule 208.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 114 for the transmission of transaction messages that include sensitive financial data and information, such as identified payment credentials. In some instances, the transmitting device 216 may be configured to transmit data to computing devices 108, parking systems 110, merchant systems 112, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to computing devices 108, which may be superimposed or otherwise encoded with merchant validation rules or data associated therewith, and data signals superimposed or otherwise encoded with validation notifications, which may include data associated with a parking validation based on compliance with a merchant validation rule. The transmitting device 216 may also be configured to electronically transmit data signals to parking systems 110 and/or merchant systems 112, such as may be superimposed or otherwise encoded with requests for merchant validation rules, validation notifications, or other data suitable for performing the functions discussed herein.

The processing server 102 may also include a memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Computing Device

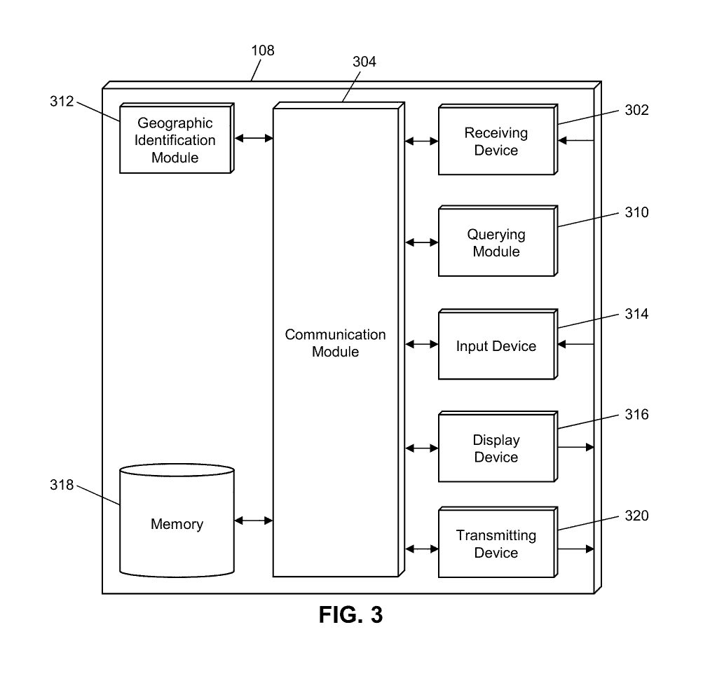

FIG. 3 illustrates an embodiment of a computing device 108 in the system 100. It will be apparent to persons having skill in the relevant art that the embodiment of the computing device 108 illustrated in FIG. 3 is provided as illustration only and may not be exhaustive to all possible configurations of the computing device 108 suitable for performing the functions as discussed herein. For example, the computer system 900 illustrated in FIG. 9 and discussed in more detail below may be a suitable configuration of the computing device 108.

The computing device 108 may include a receiving device 302. The receiving device 302 may be configured to receive data over one or more networks via one or more network protocols. In some instances, the receiving device 302 may be configured to receive data from processing servers 102, parking systems 110, merchant systems 112, and other entities via one or more communication networks and methods, such as the Internet, cellular communication network, radio frequency, Bluetooth, etc. In some embodiments, the receiving device 302 may be comprised of multiple devices, such as different receiving devices for receiving data over different networks, such as a first receiving device for receiving data over near field communication and a second receiving device for receiving data over the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by processing servers 102, which may be superimposed or otherwise encoded with merchant validation rules. The receiving device 302 may also receive data signals electronically transmitted by processing servers 102 that are superimposed or otherwise encoded with validation notifications. In some instances, the receiving device 302 may receive data signals electronically transmitted by parking systems 110 or merchant systems 112, such as may be superimposed or otherwise encoded with data related to parking areas 106 or merchants, such as geographic location data, location identifiers, etc.

The computing device 108 may also include a communication module 304. The communication module 304 may be configured to transmit data between modules, engines, databases, memories, and other components of the computing device 108 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the computing device 108 and external components of the computing device 108, such as externally connected databases, display devices, input devices, etc. The computing device 108 may also include a processing device. The processing device may be configured to perform the functions of the computing device 108 discussed herein as will be apparent to persons having skill in the relevant art. In some embodiments, the processing device may include and/or be comprised of a plurality of engines and/or modules specially configured to perform one or more functions of the processing device, such as a querying module 310, geographic identification module 312, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 108 may include a querying module 310. The querying module 310 may be configured to execute queries on databases to identify information. The querying module 310 may receive one or more data values or query strings, and may execute a query string based thereon on an indicated database, such as a memory 318 of the computing device 108, to identify information stored therein. The querying module 310 may then output the identified information to an appropriate engine or module of the computing device 108 as necessary. The querying module 310 may, for example, execute a query on the memory 318 to identify program code associated with an application program that corresponds to a parking system 110 for a parking area 106 the computing device 108 has entered, such as may be used to submit data to and receive data from the processing server 102.

The computing device 108 may also include a geographic identification module 312. The geographic identification module 312 may be configured to identify a geographic location of the computing device 108 using methods that will be apparent to persons having skill in the relevant art. In some embodiments, the geographic identification module 312 may identify the geographic location of the computing device 108 utilizing external computing systems, such as a cellular network provider. For instance, in such an embodiment, the geographic identification module 312 may generate a request for location that may be submitted to a cellular network provider, which may identify the geographic location of the computing device 108 and transmit it back to the computing device 108, to be received by the receiving device 302. In other embodiments, the geographic identification module 312 may directly identify the computing device's geographic location using suitable methods, such as cellular network triangulation, the global positioning system, the reading of a machine-readable code encoded with location data, the detection of a data signal associated with a geographic location, etc.

The computing device 108 may also include or be otherwise be interfaced with one or more input devices 314. The input devices 314 may be internal to the computing device 108 or external to the computing device 108 and connected thereto via one or more connections (e.g., wired or wireless) for the transmission of data to and/or from. The input devices 314 may be configured to receive input from a user of the computing device 108, such as the individual 104, which may be provided to another module or engine of computing device 108 (e.g., via the communication module 304) for processing accordingly. Input devices 314 may include any type of input device suitable for receiving input for the performing of the functions discussed herein, such as a keyboard, mouse, click wheel, scroll wheel, microphone, touch screen, track pad, camera, optical imager, etc. The input device 314 may be configured to, for example, receive input from the individual 104 requesting that the computing device's geographic location be identified and electronically transmitted to the processing server 102, as part of the validation of parking based on actions performed by the individual 104.

The computing device 108 may also include or be otherwise interfaced with a display device 316. The display device 316 may be internal to the computing device 108 or external to the computing device 108 and connected thereto via one or more connections (e.g., wired or wireless) for the transmission of data to and/or from. The display device 316 may be configured to display data to a user of the computing device 108, such as the individual 104. The display device 316 may be any type of display suitable for displaying data as part of the functions discussed herein, such as a liquid crystal display, light emitting diode display, thin film transistor display, capacitive touch display, cathode ray tube display, light projection display, etc. In some instances, the computing device 108 may include multiple display devices 316. The display device 316 may be configured to, for example, display a user interface to the individual 104 that displays merchant validation rules, providing the individual 104 with options for validating their parking in the parking area 106. The display device 316 may also display a validation notification to the individual 104, which may indicate a successful validation and its effect on the parking amount to be paid, if applicable. The display device 316 may also be configured to display a machine-readable code encoded with validation data, such as for reading by a parking system 110 as part of the payment process to pay for parking in the parking area 106.

The computing device 108 may also include a transmitting device 320. The transmitting device 320 may be configured to transmit data over one or more networks via one or more network protocols. In some instances, the transmitting device 320 may be configured to transmit data to processing servers 102, parking systems 110, merchant systems 112, and other entities via one or more suitable communication networks and methods, such as the Internet, cellular communication network, radio frequency, Bluetooth, near field communication, etc. In some embodiments, the transmitting device 320 may be comprised of multiple devices, such as different transmitting devices for transmitting data over different networks, such as a first transmitting device for transmitting data over near field communication and a second transmitting device for transmitting data over the Internet. The transmitting device 320 may electronically transmit data signals that have data superimposed that may be parsed by a receiving computing device. In some instances, the transmitting device 320 may include one or more modules for superimposing, encoding, or otherwise formatting data into data signals suitable for transmission.

The transmitting device 320 may be configured to electronically transmit data signals to processing servers 102, which may be superimposed or otherwise encoded with geographic location data, such as a location identifier, coordinates, etc. The transmitting device 320 may also electronically transmit data signals to processing servers 102 that are superimposed or otherwise encoded with data association with actions performed by the individual 104, such as geographic location data for merchant visits, identifiers read from merchant locations, transaction data for payment transactions initiated with merchant systems 112, etc. The transmitting device 320 may also electronically transmit data signals to parking systems 110, such as may be superimposed or otherwise encoded with validation data. The transmitting device 320 may also be configured to electronically transmit data signals to parking systems 110 or merchant systems 112, such as for performing additional functions of the computing device 108 as discussed herein, such as for the conveyance of payment details, etc.

The computing device 108 may also include a memory 318. The memory 318 may be configured to store data for use by the computing device 108 in performing the functions discussed herein. The memory 318 may be configured to store data using suitable data formatting methods and schema and may be any suitable type of memory, such as read-only memory, random access memory, etc. The memory 318 may include, for example, encryption keys and algorithms, communication protocols and standards, data formatting standards and protocols, program code for modules and application programs of the processing device, and other data that may be suitable for use by the computing device 108 in the performance of the functions disclosed herein as will be apparent to persons having skill in the relevant art. In some embodiment 3, the memory 218 may be comprised of or may otherwise include a relational database that utilizes structured query language for the storage, identification, modifying, updating, accessing, etc. of structured data sets stored therein.

### Process for Automated Detection and Display of Parking Validation Data

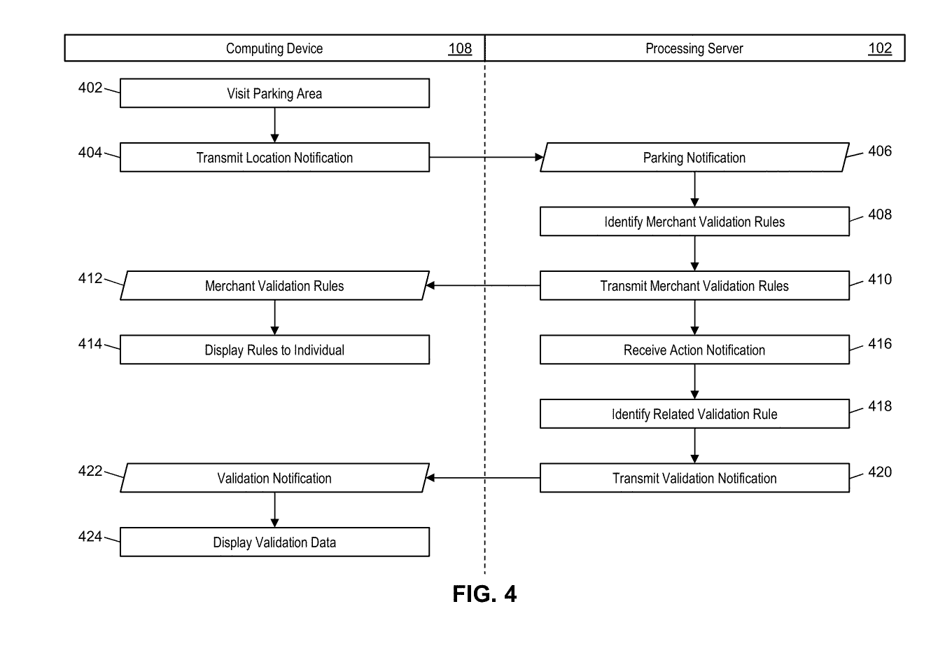

FIG. 4 illustrates a process executed using the system 100 for the automated detection of parking validation and display of data associated therewith using the computing device 108.

In step 402, the computing device 108 may arrive at the parking area 106, as may be detected by the geographic identification module 312 of the computing device 108. Arrival at the parking area 106 may be detected by the identification of a geographic location that corresponds to the parking area 106, reading of a machine-readable code displayed at the parking area 106, receipt of a data signal emitted at the parking area 106, or other suitable method. In step 404, the transmitting device 320 of the computing device 108 may electronically transmit a location notification to the processing server 102. In step 406, the receiving device 202 of the processing server 102 may receive the location notification, which may include a geographic location or location identifier associated with the parking area 106.

In step 408, the querying module 210 of the processing server 102 may execute a query on the rules database 206 of the processing server 102 to identify a plurality of merchant rules 208 associated with the parking area 106, based on the geographic location or location identifier included in the received location notification. In step 410, the transmitting device 216 of the processing server 102 may electronically transmit the identified merchant rules 208 to the computing device 108. In step 412, the receiving device 302 of the computing device 108 may receive the rules, which may be displayed to the individual 104 by the display device 316 of the computing device 108 in step 414, where the individual 104 may be able to review the merchant rules 208 to review their options for validation of their parking in the parking area 106.

In step 416, the receiving device 202 of the processing server 102 may receive an action notification, indicating an action performed by the individual 104 to be evaluated for compliance with a merchant rule 208. In some instances, the action notification may be received from the computing device 108. In other instances, the action notification may be received from a payment network 114, merchant system 112, or other entity with whom the action may be related. In step 418, the querying module 210 of the processing server 102 may execute a query on the rules database 206 to identify a merchant rule 208 associated with the action. The merchant rule 208 may be identified, for example, based on a merchant identifier included in the action notification, a geographic location included therein, or other suitable data that may be dependent on the type of action for which the processing server 102 is notified. In some embodiments, step 418 may include verification, by the verification module 212 of the computing device 108, that the action satisfies criteria associated with the identified merchant rule 208.

In step 420, the transmitting device 216 of the processing server 102 may electronically transmit a validation notification to the computing device 108. In step 422, the receiving device 302 of the computing device 108 may receive the validation notification. The validation notification may include validation data, which may be based on at least the merchant rule 208 that was satisfied based on the action of the individual 104. In some instances, the validation data may also be based on the parking of the individual 104, such as a time elapsed since the parking notification was received, the specific parking area 106 in which the individual 104 parked, etc. In step 424, the display device 316 of the computing device 108 may display the validation data for entry into the parking system 110 associated with the parking area 106. In some instances, the validation data may be encoded in a machine-readable code displayed by the display device 316 for reading by the parking system 110.

### Process for Automated Validation of Parking Based on Individual Action

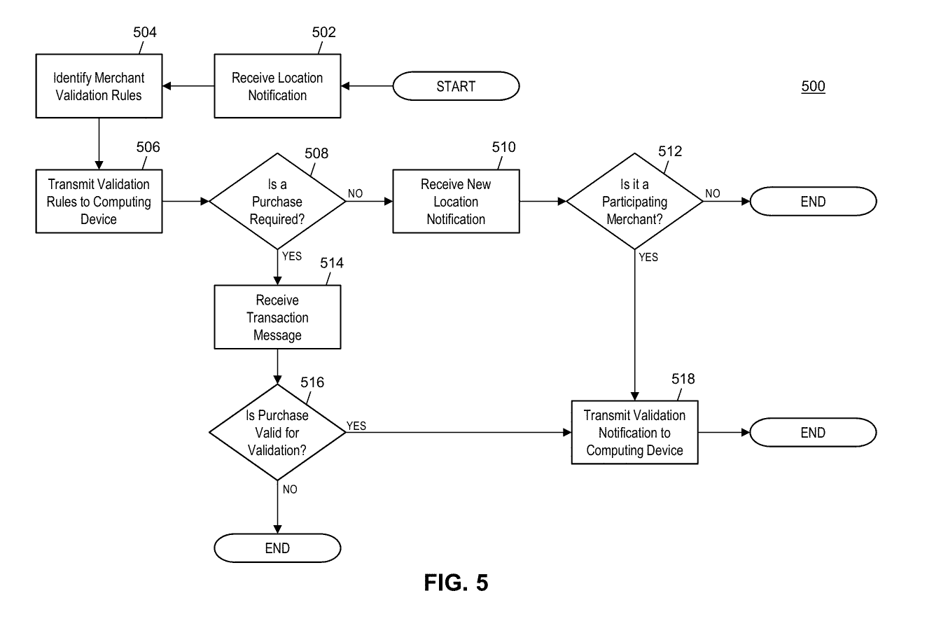

FIG. 5 illustrates a process 500 for the automatic validation of parking based on actions of an individual 104 associated therewith using the processing server 102.

In step 502, the receiving device 202 may receive a location notification, such as may be electronically transmitted by the transmitting device 320 of the computing device 108, which may include a geographic location or location identifier associated with a parking area 106. In step 504, the querying module 210 of the processing server 102 may execute a query on the rules database 206 to identify merchant rules 208 that are associated with the parking area 106, based on the geographic location or location identifier included in the location notification. In step 506, the transmitting device 216 may electronically transmit the identified merchant rules 208 or data included therein to the computing device 108, such as for display to the individual 104 as a user thereof.

In step 508, the processing server 102 may determine if a purchase is required for validation of parking in the parking area 106. Such a determination may be based on criteria included in a merchant rule 208 that was identified for the parking area 106 that is being evaluated. If a purchase is not required to satisfy the merchant rule 208, then, in step 510, the receiving device 202 of the processing server 102 may receive a new location notification from the computing device 108, reporting the geographic location of the individual 104. In step 512, the verification module 212 of the processing server 102 may determine if the individual 104 is at a participating merchant associated with the merchant rule 208, based on the geographic location included in the new location notification and a geographic location included in the merchant rule 208. If the individual 104 is not at the related merchant, then the process 500 may be completed as the individual 104 has not satisfied the merchant rule 208. If the individual 104 is at the related merchant, then, in step 518, the transmitting device 216 of the processing server 102 may electronically transmit a validation notification to the computing device 108, which may indicate that the individual 104 has satisfied the merchant rule 208 and data associated therewith (e.g., included in the new location notification).

If, in step 508, the processing server 102 determines that a purchase is required for the merchant rule 208, then the process 500 may proceed to step 514. In step 514, the receiving device 202 of the processing server 102 may receive a transaction message from the payment network 114 for a payment transaction involving the individual 104. The transaction message may be a specially formatted transaction message formatted pursuant to one or more standards governing the exchange of financial transaction messages, such as the International Organization for Standardization's ISO 8583 or ISO 20022 standards. The transaction message include data elements configured to store data for the payment transaction, including an account identifier associated with a transaction account associated with the individual 104, a merchant identifier associated with the merchant corresponding to the merchant rule 208, and additional transaction data.

In step 516, the verification module 212 of the processing server 102 may determine if the purchase made by the individual 104 is valid for validation. The determination may be based on criteria included in the merchant rule 208 and the transaction data included in the received transaction message. For instance, the criteria may specify that the transaction be of at least a specific minimum transaction amount, where the verification may verify that the transaction amount for the payment transaction is greater than the specified minimum. If the verification module 212 determines that the transaction is not valid (e.g., the transaction amount is too low), then the process 500 may be completed as the parking may not be validated as a result. If the transaction is valid for validation, then, in step 518, the transmitting device 216 of the processing server 102 may electronically transmit a validation notification to the computing device 108, which may indicate that the individual 104 has satisfied the merchant rule 208 and data associated therewith (e.g., included in the transaction message).

### First Exemplary Method for Parking Validation Based on Merchant Rule Compliance

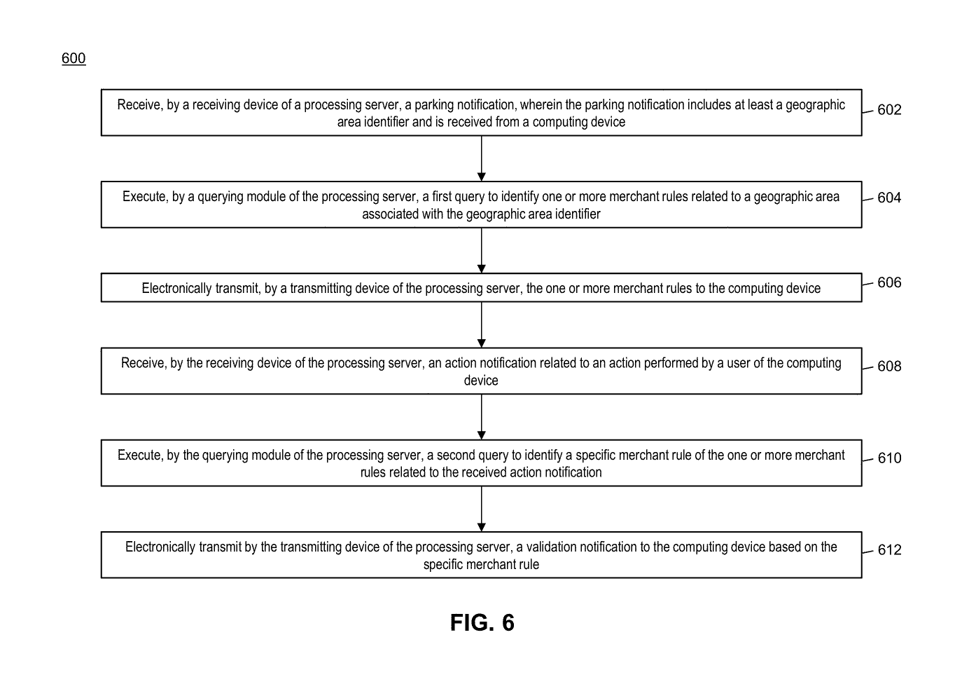

FIG. 6 illustrates a method 600 for the automated validation of parking based on compliance with a merchant validation rule.

In step 602, a parking notification may be received by a receiving device (e.g., the receiving device 202) of a processing server (e.g., the processing server 102), wherein the parking notification includes at least a geographic area identifier and is received from a computing device (e.g., the computing device 108). In step 604, a first query may be executed by a querying module (e.g., the querying module 210) of the processing server to identify one or more merchant rules (e.g., merchant rules 208) related to a geographic area (e.g., the parking area 106) associated with the geographic area identifier.

In step 606, the one or more merchant rules may be electronically transmitted by a transmitting device (e.g., the transmitting device 216) of the processing server to the computing device. In step 608, an action notification may be received by the receiving device of the processing server, wherein the action notification is related to an action performed by a user (e.g., the individual 104) of the computing device.

In step 610, a second query may be executed by the querying module of the processing server to identify a specific merchant rule of the one or more merchant rules related to the received action notification. In step 612, a validation notification may be electronically transmitted by the transmitting device of the processing server to the computing device based on the specific merchant rule.

In one embodiment, the action notification may be received from the computing device. In a further embodiment, the action notification may include a geographic location of the computing device, the geographic location corresponding to a merchant associated with the specific merchant rule. In some embodiments, the action notification may be a transaction message related to a payment transaction, which may be formatted based on one or more standards and include a plurality of data elements including at least a first data element configured to store a merchant identifier associated with the specific merchant rule. In one embodiment, the validation notification may include an expiration time based on the specific merchant rule and a time included in one of: the parking notification and the action notification.

### Second Exemplary Method for Parking Validation Based on Merchant Rule Compliance

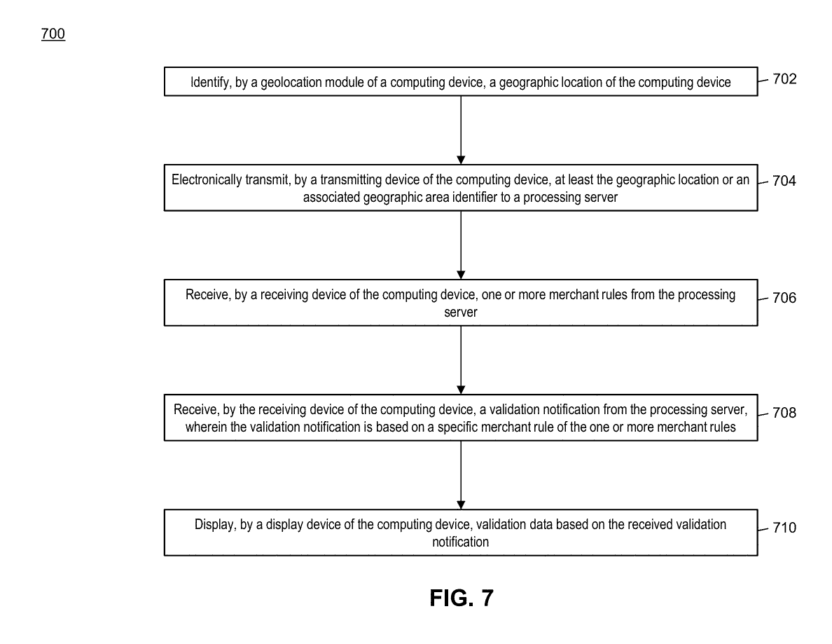

FIG. 7 illustrates a method 700 for automated parking validation based on compliance with a merchant validation rule associated therewith.

In step 702, a geographic module (e.g., the geographic identification module 312) of a computing device (e.g., the computing device 108) may identify a geographic location of the computing device. In step 704, at least the geographic location or an associated geographic area identifier may be electronically transmitted by a transmitting device (e.g., the transmitting device 320) of the computing device to a processing server (e.g., the processing server 102).

In step 706, one or more merchant rules may be received by a receiving device (e.g., the receiving device 302) of the computing device from the processing server. In step 708, a validation notification may be received by the receiving device of the computing device from the processing server, wherein the validation notification is based on a specific merchant rule of the one or more merchant rules. In step 710, validation data may be displayed by a display device (e.g., the display device 316) of the computing device based on the received validation notification.

In one embodiment, the method 700 may further include displaying, by the display device of the computing device, the received one or more merchant rules. In some embodiments, the method 700 may also include: identifying, by the geolocation module of the computing device, a second geographic location; and

electronically transmitting, by the transmitting device of the computing device, at least the second geographic location or an associated geographic area to the processing server prior to receipt of the validation notification. In a further embodiment, the second geographic location may be associated with the specific merchant rule. In one embodiment, displaying the validation data may include displaying a machine-readable code encoded with the validation data.

### Payment Transaction Processing System and Process

FIG. 8 illustrates a transaction processing system and a process 800 for the processing of payment transactions in the system, which may include the processing of thousands, millions, or even billions of transactions during a given period (e.g., hourly, daily, weekly, etc.). The process 800 and steps included therein may be performed by one or more components of the system 100 discussed above, such as the individual 104, computing device 108, parking system 110, merchant system 112, payment network 114, etc. The processing of payment transactions using the system and process 800 illustrated in FIG. 8 and discussed below may utilize the payment rails, which may be comprised of the computing devices and infrastructure utilized to perform the steps of the process 800 as specially configured and programmed by the entities discussed below, including the transaction processing server 812, which may be associated with one or more payment networks configured to processing payment transactions. It will be apparent to persons having skill in the relevant art that the process 800 may be incorporated into the processes illustrated in FIGS. 4-7, discussed above, with respect to the step or steps involved in the processing of a payment transaction. In addition, the entities discussed herein for performing the process 800 may include one or more computing devices or systems configured to perform the functions discussed below. For instance, the merchant 806 may be comprised of one or more point of sale devices, a local communication network, a computing server, and other devices configured to perform the functions discussed below.

In step 820, an issuing financial institution 802 may issue a payment card or other suitable payment instrument to a consumer 804. The issuing financial institution may be a financial institution, such as a bank, or other suitable type of entity that administers and manages payment accounts and/or payment instruments for use with payment accounts that can be used to fund payment transactions. The consumer 804 may have a transaction account with the issuing financial institution 802 for which the issued payment card is associated, such that, when used in a payment transaction, the payment transaction is funded by the associated transaction account. In some embodiments, the payment card may be issued to the consumer 804 physically. In other embodiments, the payment card may be a virtual payment card or otherwise provisioned to the consumer 804 in an electronic format.

In step 822, the consumer 804 may present the issued payment card to a merchant 806 for use in funding a payment transaction. The merchant 806 may be a business, another consumer, or any entity that may engage in a payment transaction with the consumer 804. The payment card may be presented by the consumer 804 via providing the physical card to the merchant 806, electronically transmitting (e.g., via near field communication, wireless transmission, or other suitable electronic transmission type and protocol) payment details for the payment card, or initiating transmission of payment details to the merchant 806 via a third party. The merchant 806 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 824, the merchant 806 may enter transaction details into a point of sale computing system. The transaction details may include the payment details provided by the consumer 804 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 806 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 806 may be an online retailer in an e-commerce transaction. In such embodiments, the transaction details may be entered in a shopping cart or other repository for storing transaction data in an electronic transaction as will be apparent to persons having skill in the relevant art.

In step 826, the merchant 806 may electronically transmit a data signal superimposed with transaction data to a gateway processor 808. The gateway processor 808 may be an entity configured to receive transaction details from a merchant 806 for formatting and transmission to an acquiring financial institution 810. In some instances, a gateway processor 808 may be associated with a plurality of merchants 806 and a plurality of acquiring financial institutions 810. In such instances, the gateway processor 808 may receive transaction details for a plurality of different transactions involving various merchants, which may be forwarded on to appropriate acquiring financial institutions 810. By having relationships with multiple acquiring financial institutions 810 and having the requisite infrastructure to communicate with financial institutions using the payment rails, such as using application programming interfaces associated with the gateway processor 808 or financial institutions used for the submission, receipt, and retrieval of data, a gateway processor 808 may act as an intermediary for a merchant 806 to be able to conduct payment transactions via a single communication channel and format with the gateway processor 808, without having to maintain relationships with multiple acquiring financial institutions 810 and payment processors and the hardware associated thereto. Acquiring financial institutions 810 may be financial institutions, such as banks, or other entities that administers and manages payment accounts and/or payment instruments for use with payment accounts. In some instances, acquiring financial institutions 810 may manage transaction accounts for merchants 806. In some cases, a single financial institution may operate as both an issuing financial institution 802 and an acquiring financial institution 810.

The data signal transmitted from the merchant 806 to the gateway processor 808 may be superimposed with the transaction details for the payment transaction, which may be formatted based on one or more standards. In some embodiments, the standards may be set forth by the gateway processor 808, which may use a unique, proprietary format for the transmission of transaction data to/from the gateway processor 808. In other embodiments, a public standard may be used, such as the International Organization for Standardization's ISO 8883 standard. The standard may indicate the types of data that may be included, the formatting of the data, how the data is to be stored and transmitted, and other criteria for the transmission of the transaction data to the gateway processor 808.

In step 828, the gateway processor 808 may parse the transaction data signal to obtain the transaction data superimposed thereon and may format the transaction data as necessary. The formatting of the transaction data may be performed by the gateway processor 808 based on the proprietary standards of the gateway processor 808 or an acquiring financial institution 810 associated with the payment transaction. The proprietary standards may specify the type of data included in the transaction data and the format for storage and transmission of the data. The acquiring financial institution 810 may be identified by the gateway processor 808 using the transaction data, such as by parsing the transaction data (e.g., deconstructing into data elements) to obtain an account identifier included therein associated with the acquiring financial institution 810. In some instances, the gateway processor 808 may then format the transaction data based on the identified acquiring financial institution 810, such as to comply with standards of formatting specified by the acquiring financial institution 810. In some embodiments, the identified acquiring financial institution 810 may be associated with the merchant 806 involved in the payment transaction, and, in some cases, may manage a transaction account associated with the merchant 806.

In step 830, the gateway processor 808 may electronically transmit a data signal superimposed with the formatted transaction data to the identified acquiring financial institution 810. The acquiring financial institution 810 may receive the data signal and parse the signal to obtain the formatted transaction data superimposed thereon. In step 832, the acquiring financial institution may generate an authorization request for the payment transaction based on the formatted transaction data. The authorization request may be a specially formatted transaction message that is formatted pursuant to one or more standards, such as the ISO 8883 standard and standards set forth by a payment processor used to process the payment transaction, such as a payment network. The authorization request may be a transaction message that includes a message type indicator indicative of an authorization request, which may indicate that the merchant 806 involved in the payment transaction is requesting payment or a promise of payment from the issuing financial institution 802 for the transaction. The authorization request may include a plurality of data elements, each data element being configured to store data as set forth in the associated standards, such as for storing an account number, application cryptogram, transaction amount, issuing financial institution 802 information, etc.

In step 834, the acquiring financial institution 810 may electronically transmit the authorization request to a transaction processing server 812 for processing. The transaction processing server 812 may be comprised of one or more computing devices as part of a payment network configured to process payment transactions. In some embodiments, the authorization request may be transmitted by a transaction processor at the acquiring financial institution 810 or other entity associated with the acquiring financial institution. The transaction processor may be one or more computing devices that include a plurality of communication channels for communication with the transaction processing server 812 for the transmission of transaction messages and other data to and from the transaction processing server 812. In some embodiments, the payment network associated with the transaction processing server 812 may own or operate each transaction processor such that the payment network may maintain control over the communication of transaction messages to and from the transaction processing server 812 for network and informational security.

In step 836, the transaction processing server 812 may perform value-added services for the payment transaction. Value-added services may be services specified by the issuing financial institution 802 that may provide additional value to the issuing financial institution 802 or the consumer 804 in the processing of payment transactions. Value-added services may include, for example, fraud scoring, transaction or account controls, account number mapping, offer redemption, loyalty processing, etc. For instance, when the transaction processing server 812 receives the transaction, a fraud score for the transaction may be calculated based on the data included therein and one or more fraud scoring algorithms and/or engines. In some instances, the transaction processing server 812 may first identify the issuing financial institution 802 associated with the transaction, and then identify any services indicated by the issuing financial institution 802 to be performed. The issuing financial institution 802 may be identified, for example, by data included in a specific data element included in the authorization request, such as an issuer identification number. In another example, the issuing financial institution 802 may be identified by the primary account number stored in the authorization request, such as by using a portion of the primary account number (e.g., a bank identification number) for identification.

In step 838, the transaction processing server 812 may electronically transmit the authorization request to the issuing financial institution 802. In some instances, the authorization request may be modified, or additional data included in or transmitted accompanying the authorization request as a result of the performance of value-added services by the transaction processing server 812. In some embodiments, the authorization request may be transmitted to a transaction processor (e.g., owned or operated by the transaction processing server 812) situated at the issuing financial institution 802 or an entity associated thereof, which may forward the authorization request to the issuing financial institution 802.

In step 840, the issuing financial institution 802 may authorize the transaction account for payment of the payment transaction. The authorization may be based on an available credit amount for the transaction account and the transaction amount for the payment transaction, fraud scores provided by the transaction processing server 812, and other considerations that will be apparent to persons having skill in the relevant art. The issuing financial institution 802 may modify the authorization request to include a response code indicating approval (e.g., or denial if the transaction is to be denied) of the payment transaction. The issuing financial institution 802 may also modify a message type indicator for the transaction message to indicate that the transaction message is changed to be an authorization response. In step 842, the issuing financial institution 802 may transmit (e.g., via a transaction processor) the authorization response to the transaction processing server 812.

In step 844, the transaction processing server 812 may forward the authorization response to the acquiring financial institution 810 (e.g., via a transaction processor). In step 846, the acquiring financial institution may generate a response message indicating approval or denial of the payment transaction as indicated in the response code of the authorization response, and may transmit the response message to the gateway processor 808 using the standards and protocols set forth by the gateway processor 808. In step 848, the gateway processor 808 may forward the response message to the merchant 806 using the appropriate standards and protocols. In step 880, assuming the transaction was approved, the merchant 806 may then provide the products purchased by the consumer 804 as part of the payment transaction to the consumer 804.

In some embodiments, once the process 800 has completed, payment from the issuing financial institution 802 to the acquiring financial institution 810 may be performed. In some instances, the payment may be made immediately or within one business day. In other instances, the payment may be made after a period of time, and in response to the submission of a clearing request from the acquiring financial institution 810 to the issuing financial institution 802 via the transaction processing server 812. In such instances, clearing requests for multiple payment transactions may be aggregated into a single clearing request, which may be used by the transaction processing server 812 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 840), the transaction processing server 812 may be configured to perform authorization of transactions on behalf of the issuing financial institution 802. Such actions may be referred to as “stand-in processing,” where the transaction processing server “stands in” as the issuing financial institution 802. In such instances, the transaction processing server 812 may utilize rules set forth by the issuing financial institution 802 to determine approval or denial of the payment transaction, and may modify the transaction message accordingly prior to forwarding to the acquiring financial institution 810 in step 844. The transaction processing server 812 may retain data associated with transactions for which the transaction processing server 812 stands in, and may transmit the retained data to the issuing financial institution 802 once communication is reestablished. The issuing financial institution 802 may then process transaction accounts accordingly to accommodate for the time of lost communication.

In another example, if the transaction processing server 812 is unavailable for submission of the authorization request by the acquiring financial institution 810, then the transaction processor at the acquiring financial institution 810 may be configured to perform the processing of the transaction processing server 812 and the issuing financial institution 802. The transaction processor may include rules and data suitable for use in making a determination of approval or denial of the payment transaction based on the data included therein. For instance, the issuing financial institution 802 and/or transaction processing server 812 may set limits on transaction type, transaction amount, etc. that may be stored in the transaction processor and used to determine approval or denial of a payment transaction based thereon. In such instances, the acquiring financial institution 810 may receive an authorization response for the payment transaction even if the transaction processing server 812 is unavailable, ensuring that transactions are processed and no downtime is experienced even in instances where communication is unavailable. In such cases, the transaction processor may store transaction details for the payment transactions, which may be transmitted to the transaction processing server 812 (e.g., and from there to the associated issuing financial institutions 802) once communication is reestablished.

In some embodiments, transaction processors may be configured to include a plurality of different communication channels, which may utilize multiple communication cards and/or devices, to communicate with the transaction processing server 812 for the sending and receiving of transaction messages. For example, a transaction processor may be comprised of multiple computing devices, each having multiple communication ports that are connected to the transaction processing server 812. In such embodiments, the transaction processor may cycle through the communication channels when transmitting transaction messages to the transaction processing server 812, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 810 may identify that an authorization request involves an issuing financial institution 802 (e.g., via the bank identification number included in the transaction message) for which no value-added services are required. The transaction processor at the acquiring financial institution 810 may then transmit the authorization request directly to the transaction processor at the issuing financial institution 802 (e.g., without the authorization request passing through the transaction processing server 812), where the issuing financial institution 802 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 812 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 808, acquiring financial institution 810, etc.) for processing using this advanced network, and to quickly and efficiently receive a response regarding the ability for a consumer 804 to fund the payment transaction.

### Computer System Architecture

FIG. 9 illustrates a computer system 900 in which embodiments of the present disclosure, or portions thereof, may be implemented as computer-readable code. For example, the processing server 102 and computing device 108 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4-8.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 4-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

Techniques consistent with the present disclosure provide, among other features, systems and methods for parking validation based on merchant rule compliance. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for parking validation based on merchant rule compliance, comprising:
receiving, by a receiving device of a processing server, a parking notification, wherein the parking notification includes at least a geographic area identifier and is received from a computing device;
executing, by a querying module of the processing server, a first query to identify one or more merchant rules related to a geographic area associated with the geographic area identifier;
electronically transmitting, by a transmitting device of the processing server, the one or more merchant rules to the computing device;
receiving, by the receiving device of the processing server, an action notification related to an action performed by a user of the computing device;
executing, by the querying module of the processing server, a second query to identify a specific merchant rule of the one or more merchant rules related to the received action notification; and
electronically transmitting, by the transmitting device of the processing server, a validation notification to the computing device based on the specific merchant rule.

2. The method of claim 1, wherein the action notification is received from the computing device.

3. The method of claim 2, wherein the action notification includes a geographic location of the computing device, the geographic location corresponding to a merchant associated with the specific merchant rule.

4. The method of claim 1, wherein the action notification is a transaction message related to a payment transaction, is formatted based on one or more standards, and includes a plurality of data elements including at least a first data element configured to store a merchant identifier associated with the specific merchant rule.

5. The method of claim 1, wherein the validation notification includes an expiration time based on the specific merchant rule and a time included in one of: the parking notification and the action notification.

6. A method for parking validation based on merchant rule compliance, comprising:
identifying, by a geolocation module of a computing device, a geographic location of the computing device;
electronically transmitting, by a transmitting device of the computing device, at least the geographic location or an associated geographic area identifier to a processing server;
receiving, by a receiving device of the computing device, one or more merchant rules from the processing server;
receiving, by the receiving device of the computing device, a validation notification from the processing server, wherein the validation notification is based on a specific merchant rule of the one or more merchant rules; and
displaying, by a display device of the computing device, validation data based on the received validation notification.

7. The method of claim 6, further comprising:
displaying, by the display device of the computing device, the received one or more merchant rules.

8. The method of claim 6, further comprising:
identifying, by the geolocation module of the computing device, a second geographic location; and
electronically transmitting, by the transmitting device of the computing device, at least the second geographic location or an associated geographic area to the processing server prior to receipt of the validation notification.

9. The method of claim 8, wherein the second geographic location is associated with the specific merchant rule.

10. The method of claim 6, wherein displaying the validation data includes displaying a machine-readable code encoded with the validation data.

11. A system for parking validation based on merchant rule compliance, comprising:
a receiving device of a processing server configured to receive a parking notification, wherein the parking notification includes at least a geographic area identifier and is received from a computing device;
a querying module of the processing server configured to execute a first query to identify one or more merchant rules related to a geographic area associated with the geographic area identifier; and
a transmitting device of the processing server configured to electronically transmit the one or more merchant rules to the computing device, wherein
the receiving device of the processing server is further configured to receive an action notification related to an action performed by a user of the computing device,
the querying module of the processing server is further configured to execute a second query to identify a specific merchant rule of the one or more merchant rules related to the received action notification, and
the transmitting device of the processing server is further configured to electronically transmit a validation notification to the computing device based on the specific merchant rule.

12. The system of claim 11, wherein the action notification is received from the computing device.

13. The system of claim 12, wherein the action notification includes a geographic location of the computing device, the geographic location corresponding to a merchant associated with the specific merchant rule.

14. The system of claim 11, wherein the action notification is a transaction message related to a payment transaction, is formatted based on one or more standards, and includes a plurality of data elements including at least a first data element configured to store a merchant identifier associated with the specific merchant rule.

15. The system of claim 11, wherein the validation notification includes an expiration time based on the specific merchant rule and a time included in one of: the parking notification and the action notification.

16. A system for parking validation based on merchant rule compliance, comprising:
a geolocation module of a computing device configured to identify a geographic location of the computing device;
a transmitting device of the computing device configured to electronically transmit at least the geographic location or an associated geographic area identifier to a processing server;
a receiving device of the computing device configured to
receive one or more merchant rules from the processing server, and
receive a validation notification from the processing server, wherein the validation notification is based on a specific merchant rule of the one or more merchant rules; and
a display device of the computing device configured to display validation data based on the received validation notification.

17. The system of claim 16, wherein the display device of the computing device is further configured to display the received one or more merchant rules.

18. The system of claim 16, wherein
the geolocation module of the computing device is further configured to identify a second geographic location, and
the transmitting device of the computing device is further configured to electronically transmit at least the second geographic location or an associated geographic area to the processing server prior to receipt of the validation notification.

19. The system of claim 18, wherein the second geographic location is associated with the specific merchant rule.

20. The system of claim 16, wherein displaying the validation data includes displaying a machine-readable code encoded with the validation data.
